(19) United States
(12) Patent Application Publication
(10) Pub. No.: US 2009/0034176 A1
(43) Pub. Date: Feb. 5, 2009

(54) Plasma display panel and method of manufacturing exhausting hole of the plasma display panel

(76) Inventors: Jin-Nam Kim, Suwon-si (KR); Jung-Hyuck Choi, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 12/008,622

(22) Filed: Jan. 10, 2008

(30) Foreign Application Priority Data
Aug. 3, 2007 (KR) 10-2007-0078161

(51) Int. Cl. G06F 1/16; H01J 61/52

(52) U.S. Cl. 361/681; 313/11

(57) ABSTRACT

A method of easily manufacturing an exhaust hole of a plasma display panel, the method including the operations of arranging a laser on one side of a substrate and arranging a reflective plate in line with the laser on the other opposite side of the substrate, radiating a laser beam of the laser to the substrate, and forming the exhaust hole by cooling the substrate.

### CROSS-REFERENCE TO RELATED PATENT APPLICATION

This application claims the benefit of Korean Patent Application No. 10-2007-0078161, filed on Aug. 3, 2007, in the Korean Intellectual Property Office, the disclosure of which is incorporated herein in its entirety by reference.

### BACKGROUND OF THE INVENTION

1. Field of the Invention

The present embodiments relate to a plasma display panel (PDP) and a method of manufacturing an exhausting hole of the PDP, more specifically, to a PDP capable of being easily manufactured and a method of manufacturing an exhausting hole of the PDP.

2. Description of the Related Art

PDPs display images using a gas discharge and can provide large screens and certain advantages, such as a high-quality image display, a high brightness, a high contrast, less image sticking, a very thin and light design, and a wide-range viewing angle. Hence, PDPs have attracted considerable attention as the most promising next-generation flat display devices.

General PDPs are formed by coupling a front panel with a rear panel. A rear substrate of the rear panel includes exhausting holes to exhaust impure gases within a discharge space and receive a discharge gas to be applied to the discharge space. The exhausting holes are generally formed using a drill. FIG. 1 illustrates a picture of a side of an exhaust hole formed in a rear substrate according to a drilling process. This kind of exhaust holes are formed by drilling before electrodes, a dielectric layer, barrier ribs, and phosphor layers are formed on the rear substrate. Accordingly, when three or more baking processes are performed to form the electrodes, the dielectric layer, the barrier ribs, and the phosphor layers on the rear substrate having the exhaust holes, the exhaust holes may be damaged, because the exhaust holes have cracks or the like by the drilling process. In addition, when the exhaust holes are formed by the drilling process, glass chips spread in the working space.

Thus, a conventional method of forming exhaust holes using a drilling process lowers the quality of exhaust holes and deteriorates the working environments, thus making it difficult to manufacture PDPs. The present embodiments overcome such drawbacks and provide these and other advantages.

### SUMMARY OF THE INVENTION

The present embodiments provide a plasma display panel (PDP) capable of being easily manufactured and a method of manufacturing exhausting holes of the PDP.

According to an aspect of the present embodiments, there is provided a method of manufacturing an exhaust hole of a plasma display panel, the method comprising: arranging a laser on one side of a substrate and arranging a reflective plate in line with the laser on the other opposite side of the substrate; radiating a laser beam of the laser to the substrate; and forming the exhaust hole by cooling the substrate.

According to another aspect of the present embodiments, there is provided a method of manufacturing an exhaust hole of a plasma display panel, the method comprising; arranging electrodes on a substrate; arranging a dielectric layer on the substrate to cover the electrodes; disposing a laser to face one of the substrate and the dielectric layer and disposing a reflective plate in line with the laser to face the other one; radiating a laser beam of the laser to the substrate and the dielectric layer; and forming the exhaust hole by cooling the substrate and the dielectric layer.

According to another aspect of the present embodiments, there is provided a plasma display panel comprising: a first substrate; and a second substrate disposed to face the first substrate, defining an internal space together with the first substrate, and being coupled to the first substrate, wherein an exhaust hole through which an impure gas within a discharge space is exhausted is formed on one of the first and second substrates, and an area of an end of the exhaust hole is greater than an area of the other end of the exhaust hole.

### BRIEF DESCRIPTION OF THE DRAWINGS

The above and other features and advantages of the present embodiments will become more apparent by describing in detail exemplary embodiments thereof with reference to the attached drawings in which:

FIG. 1 is a picture of a side of a conventional exhaust hole formed in a rear substrate according to a drilling process;

FIG. 2 is a flowchart illustrating a method of manufacturing exhaust holes, according to an embodiment; and

FIGS. 3A through 3G are cross-sectional views illustrating a process of forming an exhaust hole according to the sequence illustrated in FIG. 1;

FIGS. 4A through 4C are pictures of an exhaust hole manufactured according to the method shown in FIG. 2 but not yet undergoing a cutting process;

FIGS. 5A, 5B, 6A, and 6B are cross-sectional views of exhaust holes that can be manufactured according to the method shown in FIG. 2;

FIG. 7 is a flowchart illustrating a method of manufacturing exhaust holes, according to another embodiment;

FIGS. 8A through 8I are cross-sectional views illustrating a process of forming an exhaust hole according to the sequence illustrated in FIG. 7; and

FIG. 9 is a schematic cross-section of a part of a plasma display panel according to an embodiment.

### DETAILED DESCRIPTION OF THE INVENTION

The present embodiments will now be described more fully with reference to the accompanying drawings, in which exemplary embodiments are shown.

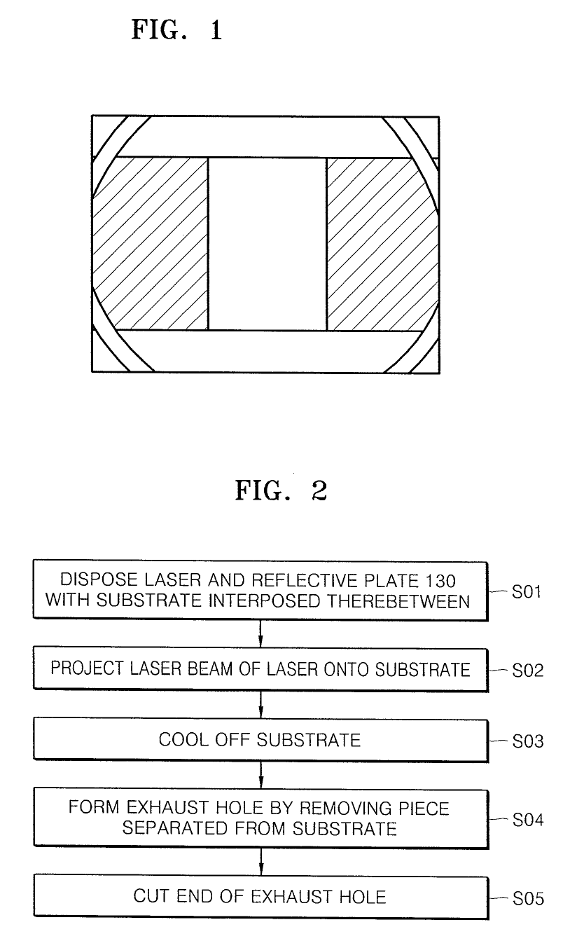

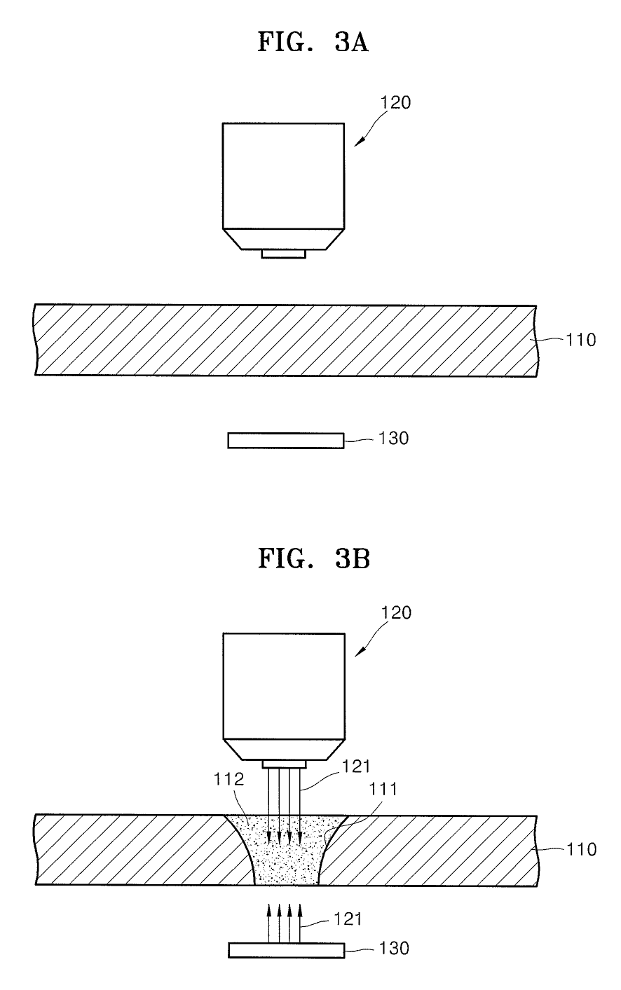

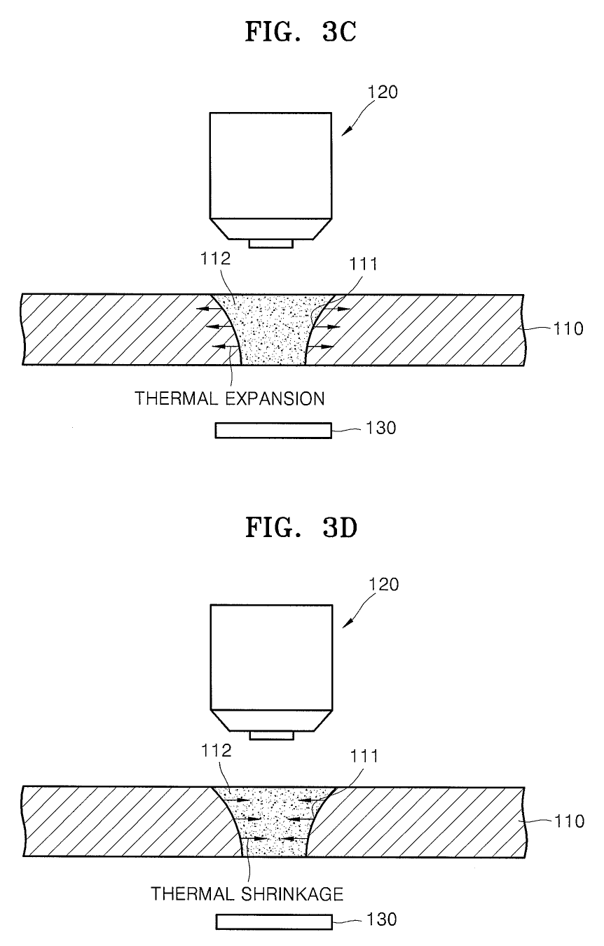

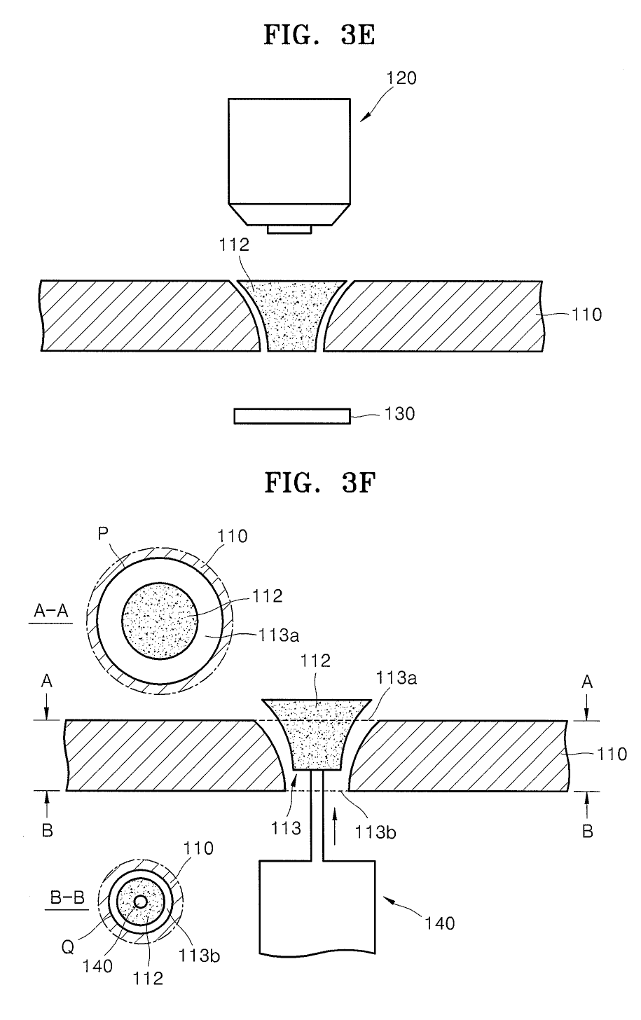

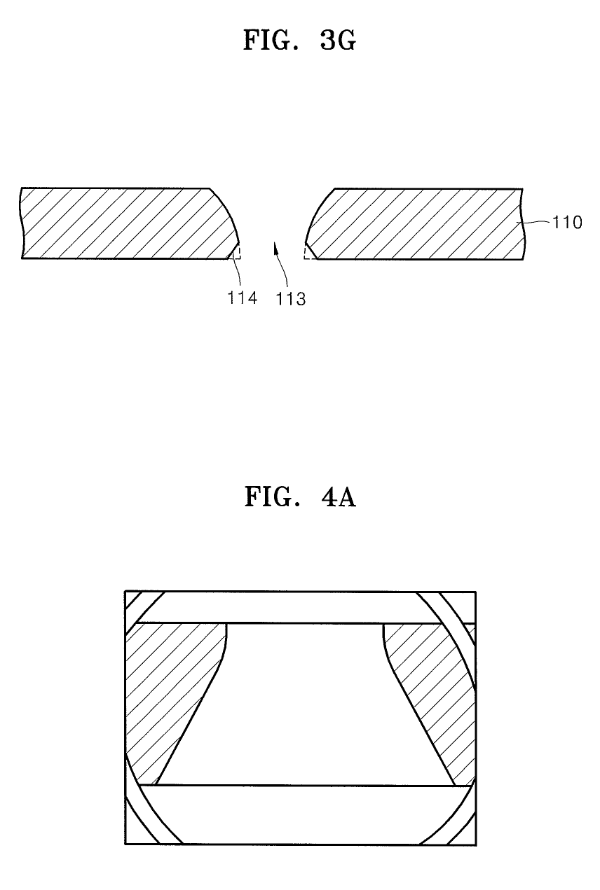

FIG. 2 is a flowchart illustrating a method of manufacturing exhaust holes, according to an embodiment. FIGS. 3A through 3G are cross-sectional views illustrating a process of forming an exhaust hole according to the sequence illustrated in FIG. 1.

A laser 120 is disposed over a substrate 110, and a reflective plate 130 is disposed under the substrate 110. In operation S01, the reflective plate 130 is aligned with the laser 120. The substrate 110 can be made of a transparent material, for example, glass. Referring to FIG. 3A, the laser 120 and the reflective plate 130 face each other with the substrate 110 interposed therebetween. The laser 120 can be, for example, a disc-type YAG laser with a wavelength of about 1030 nm. However, the laser 120 is not limited to this but may be any suitable laser, such as a YAG laser with a wavelength of about 335 nm, about 530 nm, or about 1064 nm, etc. The wavelength of the YAG laser is preferably in an infrared and visible light range between about 700 nm and about 1500 nm.

In operation S02, a laser beam 121 of the laser 120 is projected onto the upper surface of the substrate 110 for a predetermined period of time. The time required to radiate the laser beam 121 can be around several seconds. In some embodiments, the laser 120 has a Gaussian structure and the laser beam 121 has a circular horizontal cross-section. When the laser beam 121 is projected onto the substrate 110, a part of the laser beam 121 is absorbed by the substrate 110, and the other part thereof is transmitted by the substrate 110. The transmitted laser beam is reflected by the reflective plate 130 and propagates back to the bottom surface of the substrate 110. The projection of the laser beam 121 onto the substrate 110 is illustrated in FIG. 3B. In FIG. 3B, a boundary surface 111 is directly affected by the laser beam 121 and corresponds to an inner surface of an exhaust hole 113 (see FIG. 3F) to be formed later.

The reflective plate 130 may be any of various kinds in consideration of the shape of the exhaust hole 113. When the reflective plate 130 has a high reflectance, the amount of laser beam reflected to the bottom surface of the substrate 110 increases, leading to an increase in the amount of laser beam absorbed by the bottom surface of the substrate 110.

When the laser beam 121 is absorbed by the substrate 110, the temperature of a portion 112 of the substrate 110 that is defined by the boundary surface 111 increases, the surface and inside of the portion 112 expand from the heat and melt. At this time, the boundary surface 111 gradually expands. The change of the inside of the portion 112 occurs substantially simultaneously with the radiation of the laser beam 121. In particular, even after the radiation of the laser beam 121 is concluded, the change of the inside of the portion 112 due to the energy of the absorbed laser beam can continue. The state of the inside of the substrate 110 when the radiation of the laser beam 121 is completed is illustrated in FIG. 3C.

Thereafter, in operation S03, the substrate 110 is cooled. The cooling of the substrate 110 may be performed using various methods. The substrate 110 may undergo a cooling process after its temperature is kept a room temperature. The cooling process is usually performed after the radiation of the laser beam 121 is concluded. During the cooling process, the temperature of the portion 112 to which the laser beam 121 has been projected decreases, and the boundary surface 111 shrinks. Due to this shrinkage, the boundary surface 111 becomes cracked, so that the portion 112 to which the laser beam 121 has been projected is separated from the substrate 110 as illustrated in FIG. 3E. The separated portion 112 corresponds to the exhaust hole 113. The cooling process may be performed by spraying a gas with a low temperature to the substrate 110. In this case, the cooling process can be rapidly concluded.

In operation S04, when the portion 112 is separated from the substrate 110, it is removed using a push pin 140 as illustrated in FIG. 3F. The removal of the portion 112 results in the exhaust hole 113. The horizontal cross-section of the exhaust hole 113 is substantially circular, oval or elliptical. A size P of an end 113a facing the laser 120 is greater than a size Q of an end 113b facing the reflective plate 130, because the amount of energy of a laser beam 121 directly absorbed by the substrate 110 is greater than that of a laser beam 121 reflected by the reflective plate 130 and then absorbed by the substrate 110. The end 113a, facing the laser 120, has a diameter of from about 2 to about 4 mm, and the end 113b, facing the reflective plate 130, has a diameter of from about 1.5 to about 3.5 mm.

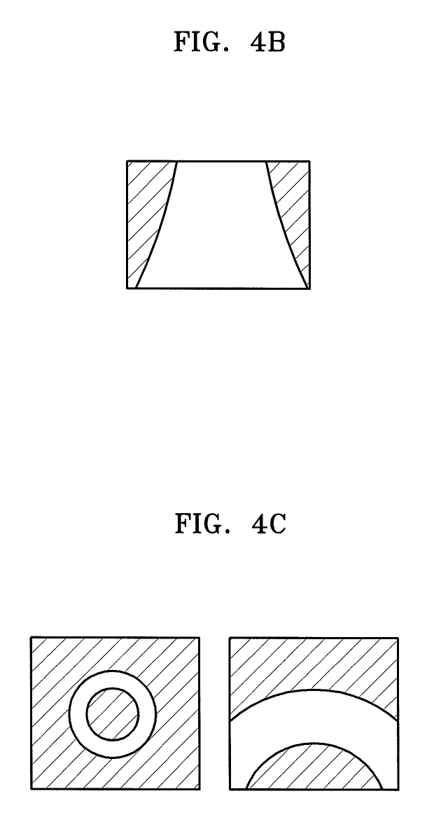

FIG. 4A illustrates a picture of a side of the exhaust hole 113 taken by a scanning electronic microscope (SEM). FIG. 4B illustrates a picture of a side of the exhaust hole 113 taken by an optical microscope. FIG. 4C illustrates a picture of a top side of the exhaust hole 113. The substrates 113 of FIGS. 4A and 4B are upside down. Referring to FIGS. 4A through 4C, the inner surface of the exhaust hole 113 is smooth, so that the quality of the exhaust hole 113 is improved. The exhaust hole 113 has a nozzle shape, such that generation of a swirl is reduced when a discharge gas is inserted through the exhaust hole 113 or when an exhaust gas is discharged therethrough. Therefore, gas insertion and exhaustion become easier, and the time required for the gas insertion and exhaustion is decreased.

Then, in operation S04, the end 113b of the exhaust hole 113 is cut as illustrated in FIG. 3G. A cutting 114 is performed on the end 113b facing the reflective plate 130.

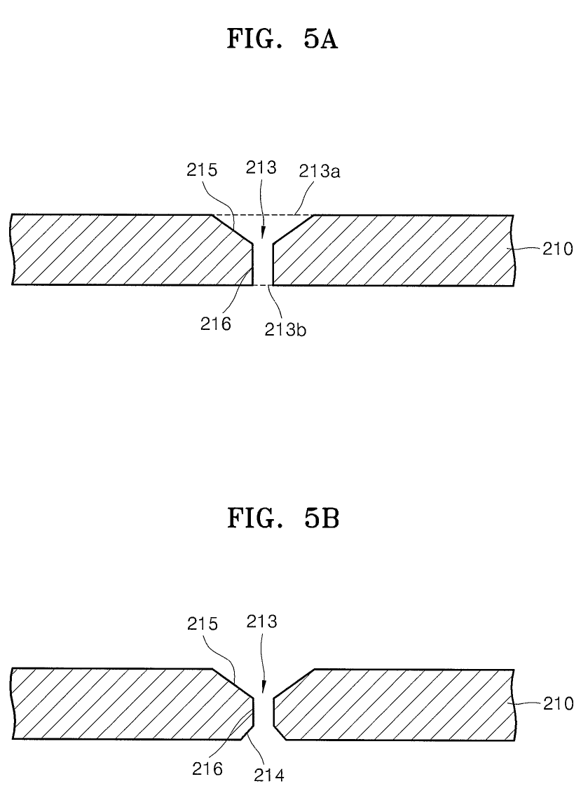

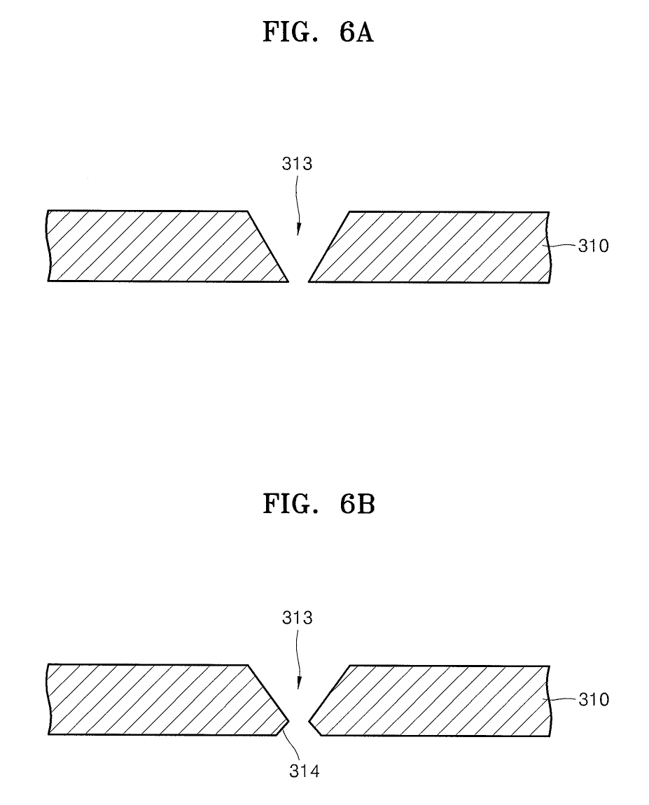

The amount of energy of the laser beam 121 absorbed by the substrate 110 after being reflected by the reflective plate 130 can be adjusted by controlling the reflectance of the reflective plate 130. The size Q of the end 113b can also be adjusted accordingly. FIGS. 5A, 5B, 6A, and 6B are cross-sectional views of exhaust holes 213 and 313 manufactured according to the method shown in FIG. 2. Referring to FIG. 5A, the exhaust hole 213 is formed on a substrate 210. The horizontal cross-section of the exhaust hole 213 is substantially circular, oval or elliptical. The exhaust hole 213 includes a first exhaust part 215 having a horizontal cross-section that narrows in a direction from one end 213a to the other end 213b, and a second exhaust part 216 extending from the first exhaust part 215 and having a horizontal cross-section whose area is substantially constant. FIG. 5B illustrates a structure obtained by cutting the end 213b of the exhaust hole 213 shown in FIG. 5A to have a cut surface 214.

Referring to FIG. 6A, the exhaust hole 313 is formed on a substrate 310. The horizontal cross-section of the exhaust hole 313 is substantially circular, oval or elliptical. The exhaust hole 313 has a horizontal cross-section that narrows as going from one end 313a to the other end 313b. FIG. 6B illustrates a structure obtained by cutting the end 313b of the exhaust hole 313 shown in FIG. 6A to have a cut surface 314.

Generally, it takes from about 20 to about 25 seconds to form an exhaust hole using a drill. However, in the present embodiment, an exhaust hole can be manufactured within about 5 seconds, so that the time required to form all exhaust holes is greatly reduced. In addition, in some methods, special refrigerant equipment is required because of drilling. However, in the present embodiment, the manufacture of the exhaust holes can be completed without refrigerant equipment. Moreover, in some methods, glass chips are generated due to drilling. However, in the present embodiment, no glass chips are generated, so that the manufacturing environment is improved.

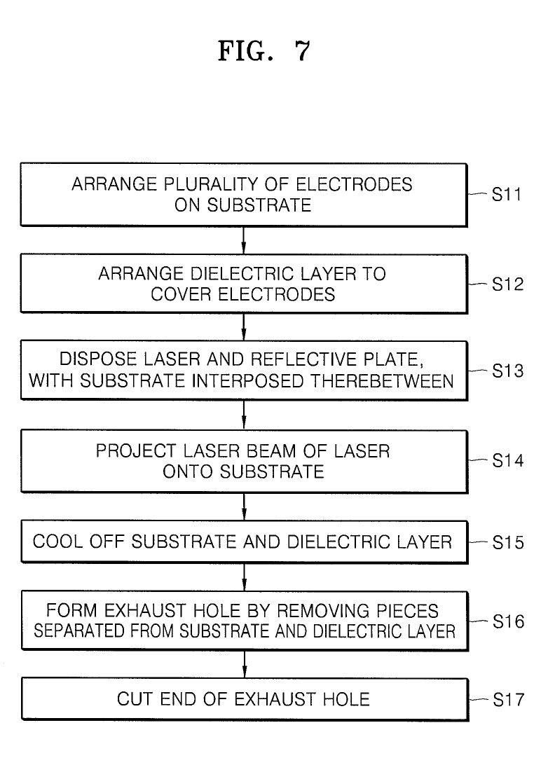

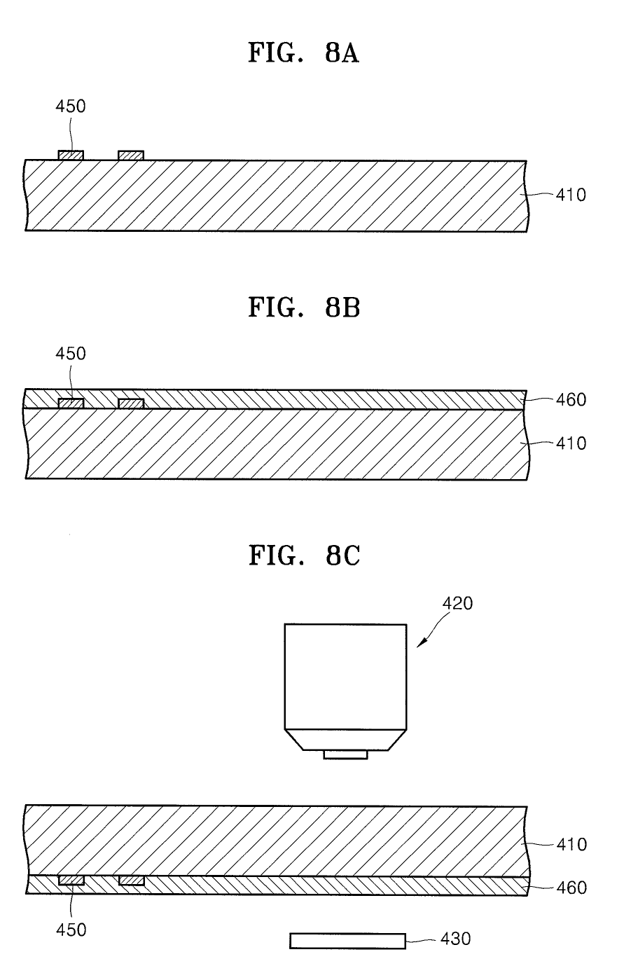

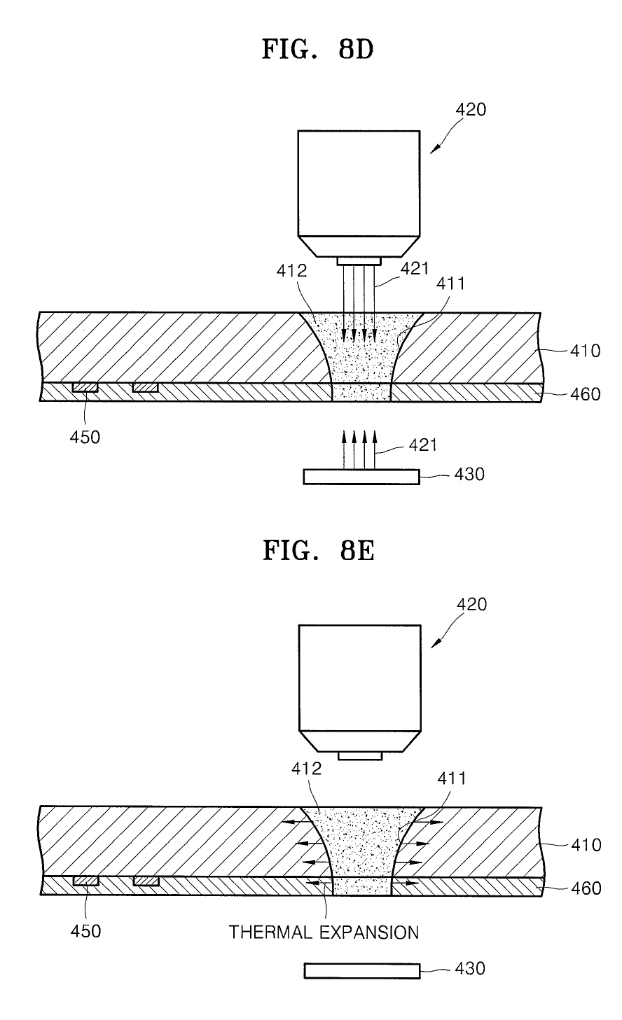

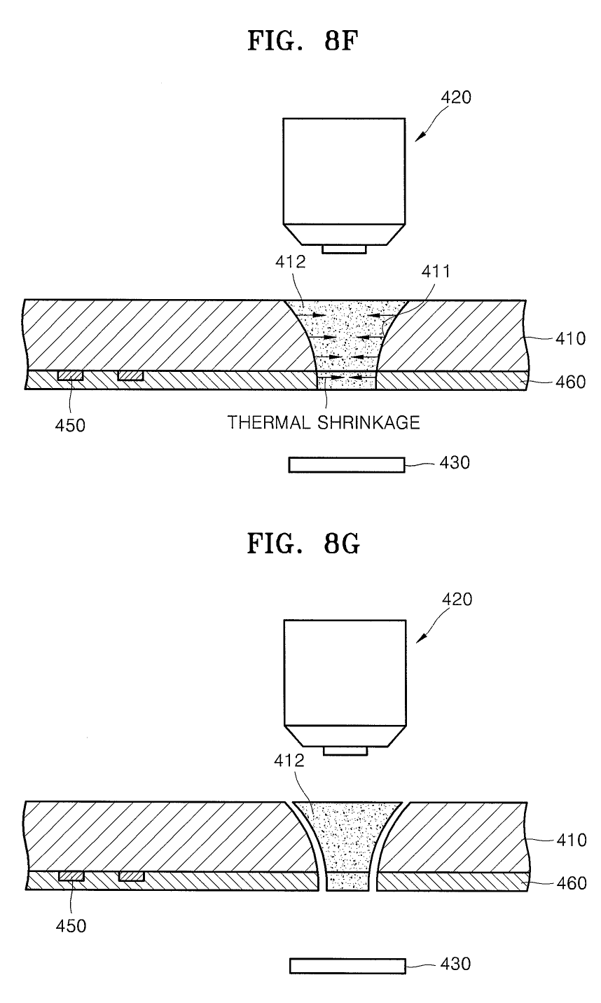

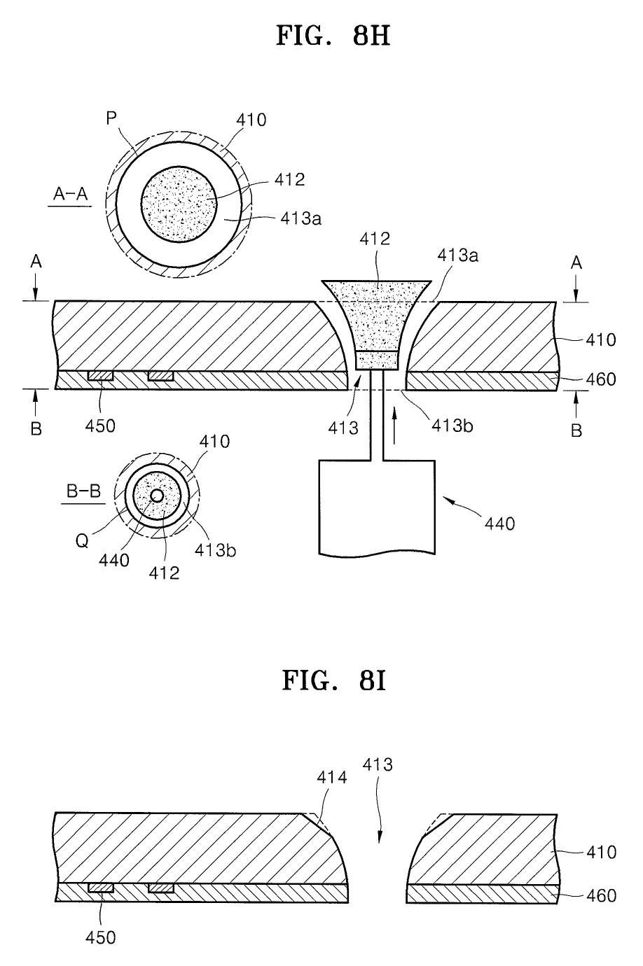

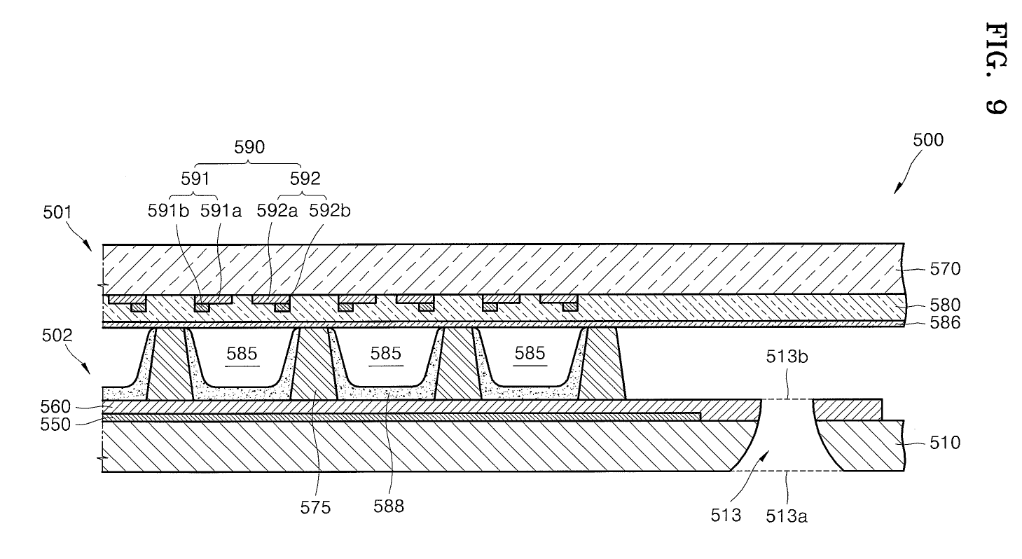

FIG. 7 is a flowchart illustrating a method of manufacturing exhaust holes, according to another embodiment. FIGS. 8A through 81 are cross-sectional views illustrating a process of forming an exhaust hole according to the sequence illustrated in FIG. 7.

First, in operation S11, a plurality of electrodes 450 are arranged on a substrate 410 as illustrated in FIG. 8A. The electrodes 450 may be arranged by photo-etching or photolithography. Thereafter, in operation S12, a dielectric layer 460 covers the electrodes 450 as illustrated in FIG. 8B. The dielectric layer 460 may be formed by printing, for example. After the formation of the dielectric layer 460, barrier ribs (not shown) and phosphor layers (not shown) may be formed on the dielectric layer 460. In some embodiments, a baking process for forming the barrier ribs and the phosphor layers is completed before forming exhaust holes, so that the probability of damage of the exhaust holes is decreased.

As illustrated in FIG. 8C, a laser 420 is disposed in opposite to the substrate 410, and a reflective plate 430 is disposed in opposite to the dielectric layer 460. In operation S13, the reflective plate 430 is aligned with the laser 420. However, the reflective plate 430 may be disposed in opposite to the substrate 410, and the laser 420 may be disposed in opposite to the dielectric layer 460. In some embodiments, the laser 420 can be a YAG laser with a wavelength of 1030 nm. However, the laser 420 is not limited to this but may be any suitable laser, such as a YAG laser with a wavelength of about 335 nm, about 530 nm, or about 1064 nm, etc. The wavelength of the YAG laser is preferably in an infrared and visible light range between about 700 nm and about 1500 nm.

In operation S14, a laser beam 421 of the laser 420 is projected onto the upper surface of the substrate 410 for a predetermined period of time. When the laser beam 421 is projected onto the substrate 410, a part of the laser beam 421 is absorbed by the substrate 410 and the dielectric layer 460, and the other part thereof is transmitted by the substrate 410 and the dielectric layer 460. The transmitted laser beam is reflected by the reflective plate 130 and is projected back to the dielectric layer 460 and the substrate 410. The projection of the laser beam 421 to the substrate 410 and the dielectric layer 460 is illustrated in FIG. 8D. In FIG. 8D, a boundary surface 411 is directly affected by the laser beam 421 and corresponds to the inner surface of an exhaust hole 413 to be formed later.

When the laser beam 421 is absorbed by the substrate 410 and the dielectric layer 460, the temperature of a portion 412 of the substrate 410 and dielectric layer 460 that is defined by the boundary surface 411 increases, the surface and inside of the portion 412 expand from the heat and melt. At this time, the boundary surface 411 gradually expands. The change of the inside of the portion 412 occurs substantially simultaneously with the radiation of the laser beam 421. In particular, even after the radiation of the laser beam 421 is concluded, the change of the inside of the portion 412 due to the energy of the absorbed laser beam continues. The states of the insides of the substrate 410 and the dielectric layer 460 when the radiation of the laser beam 421 is completed are illustrated in FIG. 8E.

Thereafter, in operation S15, the substrate 410 and the dielectric layer 460 are cooled. This cooling may be performed using various methods. The substrate 410 and the dielectric layer 460 may undergo a cooling process after their temperatures are kept a room temperature. During the cooling process, the temperature of the portion 412 to which the laser beam 421 has been projected decreases, and the boundary surface 411 shrinks. Due to this shrinkage, the boundary surface 411 is cracked, so that the portion 412 to which the laser beam 421 has been projected is separated from the substrate 410 as illustrated in FIG. 8G. The separated portion 412 corresponds to the exhaust hole 413. The cooling process may be performed by spraying a gas with a low temperature to the substrate 410 and the dielectric layer 460.

In operation S16, when the portion 412 is separated from the substrate 410 and the dielectric layer 460, it is removed using a push pin 440 as illustrated in FIG. 8H. The removal of the portion 412 results in the exhaust hole 413. The horizontal cross-section of the exhaust hole 413 is substantially circular, oval or elliptical. A size P of an end 413a facing the laser 420 is greater than a size Q of an end 413b facing the reflective plate 430.

Then, in operation S17, the end 413b of the exhaust hole 413 is cut as illustrated in FIG. 8I. A cutting 414 is performed on the end 413a facing the laser 420.

FIG. 9 is a schematic cross-section of a part of a plasma display panel (PDP) 500 according to an embodiment. Referring to FIG. 9, the PDP 500 includes a first panel 501 and a second panel 502 that face each other and are coupled with each other. The first panel 501 includes a first substrate 570, sustain electrode pairs 590, a protection layer 586, and a first dielectric layer 580. The second panel 502 includes a second substrate 510, a second dielectric layer 560, address electrodes 550, barrier ribs 575, and phosphor layers 588. The space between the first and second panels 501 and 502 is filled with a discharge gas (not shown). The space includes discharge cells 585 where discharge occurs, and non-discharge spaces.

The first substrate 570 may include a material with a high visible light transmittance, for example, glass. However, the first substrate 570 may be colored to improve the bright room contrast. The second substrate 510 is a predetermined distance apart from the first substrate 570, and the first and second substrates 570 and 510 face each other. The second substrate 510 is preferably formed of a material including glass. The second substrate 510 may also be colored to improve the bright room contrast.

The barrier ribs 575 defining the discharge cells 585, where discharge occurs, are arranged between the first and second substrates 570 and 510. The barrier ribs 575 prevent optical/electrical crosstalk between the discharge cells 585.

The sustain electrode pairs 590 are arranged apart from each other and parallel to each other on the first substrate 570, which faces the second substrate 510. Each of the sustain electrode pairs 590 includes an X electrode 591 and a Y electrode 592 and causes discharge to occur within the discharge cells 585. The X electrode 591 and the Y electrode 592 include bus electrodes 591b and 592b, respectively, and transparent electrodes 591a and 592a, respectively, electrically coupled to the bus electrodes 591b and 592b, respectively.

The first dielectric layer 580 is formed on the first substrate 570 to bury the X electrodes 591 and the Y electrodes 592. The first dielectric layer 580 prevents electrical conduction between adjacent X and Y electrodes 591 and 592 and also prevents the X and Y electrodes 591 and 592 from being damaged due to physical collisions with charged particles or electrons. Additionally, the first dielectric layer 580 induces charges.

A protection layer 580 formed of, for example, MgO can be formed on the first dielectric layer 580. The protection layer 580 prevents the first dielectric layer 580 from being damaged due to collisions with positive ions or electrons during discharge, has high light transmissivity, and emits many secondary electrons during discharge. In particular, the protection layer 586 is generally formed thinly by sputtering, electron beam deposition, or the like.

The address electrodes 550 are arranged on the second substrate 510 facing the first substrate 570 so as to intersect the X and Y electrodes 591 and 592. The address electrodes 550 generate address discharge for facilitating sustain discharge between the X and Y electrodes 591 and 592. More specifically, the address electrodes 550 lower a voltage used to generate sustain discharge. The address discharge occurs between the Y electrodes 592 and the address electrodes 550.

The second dielectric layer 560 is formed on the second substrate 510 to bury the address electrodes 550. The second dielectric layer 560 is formed of a dielectric material. The second dielectric layer 560 prevents the address electrodes 550 from being damaged due to collisions with positive ions or electrons during discharge and induces charges.

The red, green, and blue phosphor layers 588 are arranged on portions of the second dielectric layer 560 between the barrier ribs 575, which define the discharge cells 585, and lateral surfaces of the barrier ribs 575. The phosphor layers 588 receive ultraviolet (UV) light and generate visible light. The red phosphor layers formed in the red discharge cells include a phosphor, such as, Y(V,P)O₄:Eu, the green phosphor layers formed in the green discharge cells include a phosphor, such as, Zn₂SiO₄:Mn, and the blue phosphor layers formed in the blue discharge cells include a phosphor, such as, BAM:Eu.

Exhaust holes 513 are formed in portions of the second panel 502 that correspond to the non-discharge areas of the PDP 500. The exhaust holes 513 exhaust an impure gas from the discharge cells 585 and deliver a discharge gas to the discharge cells 585. The horizontal cross-sections of the exhaust holes 513 are substantially circular, oval or elliptical, and ends 513a of the exhaust holes 513 that face the outside of the PDP 500 are wider than ends 513b thereof that face the inside of the PDP 500. The ends 513a may be cut. However, the shape of the exhaust holes 513 is not limited to the present embodiment, but may be the same as the shapes of the exhaust holes illustrated in FIGS. 5A through 6B. The ends 513a facing the outside of the PDP 500 may be narrower than the ends 513b facing the inside of the PDP 500.

The exhaust holes 513 are formed in nozzle shapes. Hence, when the exhaust holes 513 receive a discharge gas or exhaust an impure gas, less eddy currents are generated. Therefore, the reception and exhaustion are performed more easily, and the time required for the reception and exhaustion is reduced.

In an operation of the PDP 500 having the above-described structure, an address discharge is generated by applying an address voltage between the address electrodes 550 and the Y electrodes 592. Consequently, discharge cells 585 where a sustain discharge is to occur are selected. Then, a sustain discharge is generated by applying a sustain voltage between the X and Y electrodes 591 and 592 of the selected discharge cells 585.

The energy level of a discharge gas excited during the sustain discharge is lowered, and simultaneously UV light is emitted. The UV light excites the phosphor layers 588 coated within the discharge cells 585. The energy level of the excited phosphor layers 588 is lowered, and simultaneously visible light is emitted. This emitted visible light forms an image.

In a PDP according to the present embodiments and a method of manufacturing exhaust holes of the PDP according to the present embodiments, the quality of the exhaust holes is improved, and the manufacturing time is shortened. Therefore, the manufacture of the PDP becomes easier.

While the present embodiments have been particularly shown and described with reference to exemplary embodiments thereof, it will be understood by those of ordinary skill in the art that various changes in form and details may be made therein without departing from the spirit and scope of the present embodiments as defined by the following claims.

What is claimed is:

1. A method of manufacturing an exhaust hole of a plasma display panel, the method comprising;
arranging a laser on one side of a substrate and arranging a reflective plate substantially in line with the laser on the other opposite side of the substrate;
radiating a laser beam of the laser to the substrate; and
forming the exhaust hole by cooling the substrate.

2. The method of claim 1, further comprising removing pieces that are separated from the substrate due to the cooling.

3. The method of claim 1, further comprising cutting an end of the exhaust hole.

4. The method of claim 2, further comprising cutting an end of the exhaust hole.

5. The method of claim 1, wherein:
a horizontal cross-section of the exhaust hole is substantially circular, oval or elliptical; and
an area of an end of the exhaust hole that faces the laser is greater than an area of an end of the exhaust hole that faces the reflective plate.

6. The method of claim 2, wherein:
a horizontal cross-section of the exhaust hole is substantially circular, oval or elliptical; and
an area of an end of the exhaust hole that faces the laser is greater than an area of an end of the exhaust hole that faces the reflective plate.

7. The method of claim 1, wherein the laser is a YAG laser.

8. A method of manufacturing an exhaust hole of a plasma display panel, the method comprising;
arranging electrodes on a substrate;
arranging a dielectric layer on the substrate to cover the electrodes;
disposing a laser to face one of the substrate and the dielectric layer and disposing a reflective plate substantially in line with the laser to face the other one;
radiating a laser beam of the laser to the substrate and the dielectric layer; and
forming the exhaust hole by cooling the substrate and the dielectric layer.

9. The method of claim 8, wherein:
the laser is disposed to face the substrate; and
the reflective plate is disposed to face the dielectric layer.

10. The method of claim 8, further comprising cutting an end of the exhaust hole.

11. The method of claim 8, further comprising removing pieces that are separated from the substrate and the dielectric layer due to the cooling.

12. The method of claim 8, wherein:
a horizontal cross-section of the exhaust hole is substantially circular, oval or elliptical; and
an area of an end of the exhaust hole that faces the laser is greater than an area of an end of the exhaust hole that faces the reflective plate.

13. The method of claim 8, wherein the laser is a YAG laser.

14. A plasma display panel comprising:
a first substrate; and
a second substrate disposed to face the first substrate, defining an internal space together with the first substrate, and being coupled to the first substrate,
wherein:
an exhaust hole through which an impure gas within a discharge space is exhausted is formed on one of the first and second substrates; and
an area of an end of the exhaust hole is greater than an area of the other end of the exhaust hole.

15. The plasma display panel of claim 14, wherein an area of an end of the exhaust hole that faces the outside of the plasma display panel is greater than an area of an end of the exhaust hole that faces the internal space.

16. The plasma display panel of one of claims 14, wherein the exhaust hole comprises:
a first exhaust part having a horizontal cross-section that narrows in a direction from the end facing the outside of the plasma display panel to the end facing the internal space; and
a second exhaust part extending from the first exhaust portion and having a horizontal cross-section whose area is substantially constant.

17. The plasma display panel of one of claims 14, wherein the exhaust hole has a horizontal cross-section that substantially narrows in a direction from the end facing the outside of the plasma display panel to the end facing the internal space.

18. The plasma display panel of claim 17, wherein the exhaust hole has a horizontal cross-section that substantially linearly narrows in the direction from the end facing the outside of the plasma display panel to the end facing the internal space.

19. The plasma display panel of one of claims 14, wherein the end of the exhaust hole that faces the outside of the plasma display panel and the end of the exhaust hole that faces the internal space are cut.

20. The plasma display panel of one of claims 14, further comprising a dielectric layer formed on the second substrate facing the first substrate,
wherein the exhaust hole is formed through the second substrate and the dielectric layer.
